(19) United States
(12) Patent Application Publication
(10) Pub. No.: US 2002/0054951 A1
(43) Pub. Date: May 9, 2002

(54) Method and apparatus for manufacturing pasty food product of animal meat

(76) Inventor: Hiroshi Hoshino, Ibaraki (JP)

Correspondence Address: McCormick, Paulding & Huber, City Place II, 185 Asylum Street, Hartford, CT, 06103-3402, US

(21) Appl. No.: 10/000,209

(22) Filed: Nov. 2, 2001

(30) Foreign Application Priority Data
Nov. 7, 2000 (JP) 2000-338622

(51) Int. Cl. A23B 4/00

(52) U.S. Cl. 426/641

(57) ABSTRACT

Being capable of manufacturing the animal meat pasty food productions formed in predetermined shapes by utilizing the animal meat paste using, as a raw material, the animal meat such as chicken meat or the like.

The animal meat such as chicken meat or the like is broken in pieces and soaked in water, and thereby fat thereof is removed. Thereafter, the animal meat paste is formed by grinding the fat-removed animal meat along with salt and moisture and the like by the grinding machine. The animal meat paste is preheated up to a temperature of 60° C. or less by the joule heat generated by current flowing in the animal meat paste, and thereby the viscosity of the animal meat paste is enhanced and begins becoming sticky. Then, the animal meat paste whose viscosity is enhanced is formed in predetermined shapes by the forming apparatus, and the formed animal meat paste is heated up to a production temperature of 75° C. or more by the joule heat generated by current flowing therein from the main heating system.

### BACKGROUND OF THE INVENTION

The present invention relates to a technology of manufacturing pasty food products using animal meat such as chicken meat or the like as a raw material.

A kamaboko (which means a boiled fish paste), a chikuwa (which means a cylindrical boiled fish paste) or the like is known as a pasty food product which uses fish meat as a raw material. In order to produce these pasty food products in great quantities, various manufacturing apparatuses have been developed. As food stuffs which use, as a raw material, domestic animal meat such as pork or the like, namely, animal meat, the animal meat preserved with salt or smoked has been known as ham, sausage or the like. On the other hand, as food stuffs which use, as a raw material, animal meat such as chicken meat or the like, a tsukune (which means a spherical fish paste) or the like which uses mince of chicken meat as a raw material has been known. However, pasty food products using chicken meat as the raw material have not been developed so far.

Thereupon, in order to develop animal meat pasty food products formed in predetermined shapes and using mainly chicken meat as a raw material, various researches and developments have been carried out. Manufacture of animal meat pasty food products has been tried by grinding chicken meat as a raw material by a grinding machine to form paste thereof, injecting the animal meat paste into molds to form it in predetermined shapes, and thereafter heating the animal meat paste put in the molds. However, unlike the pasty products using fish meat as a raw material, the animal meat paste formed by grinding the animal meat such as chicken meat or the like by the grinding machine has resulted in pasty products which are not viscous, that is, sticky and have such a sense of eating as to be dry and crumbling. If grinding operation is carried out by injecting fat such as food oil or the like thereinto, emulsification caused by protein and the fat enhances viscosity thereof. Therefore, it has been possible to make the animal meat paste stickier and improve the sense of eating. However, such the animal meat pasty food products have resulted in food stuffs having high lipid and high calorie.

### SUMMARY OF THE INVENTION

Thereupon, in order to develop animal meat pasty food products that have low calorie and are healthy, to manufacture the animal meat paste and form it in predetermined shapes has been thought. First, chicken meat has been picked from chicken, and the picked chicken meat has been broken in pieces to make mince, that is, minced meat, and the minced meat has been soaked into water because of cleaning and removing of fat floating on a surface thereof. Thus, the fat-removed chicken has been taken out from a water tank. By using the dehydrated chicken as a processing material, salt has been added thereto and the salt-added chicken has been ground by the grinding machine. Protein having a salt property has been extracted from the animal meat. Additionally, in order to improve the sense of eating, the animal meat paste has been manufactured by adding an additive such as water, albumen or the like thereto.

If pasty food products using such the animal meat paste as a raw material can be formed in predetermined shapes, it is possible to obtain animal meat paste food products that have low calorie and a soft sense of eating and are healthy. However, this animal meat paste obtained has been one that viscosity thereof is low and stickiness is lack. If stickiness of the animal meat paste is lack, when heat treatment is performed by injecting the paste into the molds and forming the paste in the predetermined shapes and thereafter taking out the paste from the molds, it is impossible to keep the predetermined shapes thereof. Thereby, it has been impossible to manufacture the animal meat pasty food products having the predetermined shapes.

An object of the present invention is to be capable of manufacturing animal meat pasty food products having predetermined shapes by using animal meat paste that uses, as a raw material, animal meat such as chicken meat or the like.

According to the present invention, a method of manufacturing an animal meat pasty food product is characterized by a fat-removing step of soaking an animal meat such as a chicken meat in water and removing fat thereof floating on a surface of water; an animal meat grinding step of grinding the fat-removed animal meat to which salt is added, along with seasonings such as moisture and albumen by a grinding machine, and thereby manufacturing an animal meat paste; a preheating step of heating said animal meat paste by joule heat generated by current flowing therein, and thereby enhancing a viscosity of said animal meat paste; a forming step of forming the animal meat pasts whose the viscosity is enhanced, in a predetermined shape; and a main heating step of heating the formed animal meat paste by joule heat generated by current flowing therein, up to a production temperature.

According to the present invention, a method of manufacturing an animal meat pasty food product is characterized by an animal meat grinding step of grinding an animal meat such as a chicken meat along with salt and moisture, and thereby forming an animal meat paste; a preheating step of heating said animal meat paste by joule heat generated by current flowing therein, and thereby enhancing a viscosity of said animal meat paste; a forming step of forming the animal meat pasts whose the viscosity is enhanced, in a predetermined shape; and a main heating step of heating the formed animal meat paste by joule heat generated by current flowing therein, up to a production temperature.

According the present invention, a method of manufacturing an animal meat pasty food product is characterized in that said preheating step is a step of heating said animal meat paste up to a temperature of 60° C. or less, and said main heating step is a step of heating said animal meat paste up to a temperature of 75° C. or more.

According to the present invention, an apparatus for manufacturing an animal meat pasty food product is characterized by a grinding machine for grinding an animal meat such as a fat-removed chicken meat along with salt and moisture, and thereby manufacturing an animal meat paste; a preheating means for heating said animal meat paste by joule heat generated by current flowing in said animal meat paste, and thereby enhancing a viscosity of said animal meat paste; a forming apparatus for forming the animal meat pasts whose the viscosity is enhanced, in a predetermined shape; and a main heating means for heating the formed animal meat paste by joule heat generated by current flowing therein, up to a production temperature. According to the present invention, an apparatus for manufacturing an animal meat pasty food product is characterized in that preheating means heats said animal meat paste up to a temperature of 60° C. or less, and said heating means heats said animal meat paste up to a temperature of 75° C. or more.

### BRIEF DESCRIPTION OF THE DRAWINGS

FIG. 1 is a flow chart showing a method of manufacturing animal meat pasty food products, which is one embodiment of the present invention.

FIG. 2 is a cross-sectional view of a preheating system used as a preheating means.

FIG. 3 is a cross-sectional view taken along line A-A in FIG. 2.

FIG. 4 is a cross-sectional view showing one example of a forming apparatus.

FIG. 5 is a front view showing a main heating system for mainly heating the animal meat paste up to a production temperature.

FIG. 6 is a cross-sectional view taken along line B-B in FIG. 5.

FIG. 7 is a perspective view of FIG. 6.

FIG. 8 is a cross-sectional view of a burning oven for performing surface finishing heating.

FIG. 9 is a lateral view showing a modified example of the main heating system.

FIG. 10 is a lateral view of another modified example of the main heating system.

### DESCRIPTION OF THE PREFERRED EMBODIMENTS

Embodiments of the present invention will be described below in detail, with referring to the accompanying drawings.

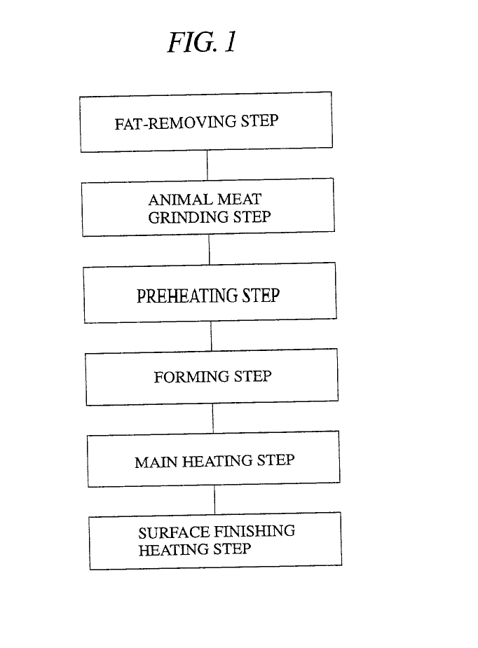

FIG. 1 is a flow chart showing a method of manufacturing animal meat pasty food products, which is one embodiment of the present invention. In order to heat animal meat pasty food products using chicken meat as a raw material, the present invention is applied. First, a processing material is manufactured which uses chicken meat as a raw material. The processing material is manufactured by breaking chicken to pieces to pick breast meat, thigh meat or the like therefrom, and further cutting scraps of the picked meat to pieces by cutter or the like, and making mince, that is, minced meat by a minced meat manufacture machine, and soaking the minced meat into water because of cleaning and removing of fat floating on a water surface, and taking out the fat-removed chicken meat from a water tank to perform a dehydration treatment.

In an animal meat grinding step of throwing and grinding this processing material in a grinding machine, animal meat paste is manufactured by grinding animal meat. At this time, by putting salt, moisture and albumen along with the chicken meat in the grinding machine, the animal meat paste is manufactured. Amounts of moisture injected therein may preferably be about 30 to 100% of the animal meat by weight rate or be any amounts that correspond to kinds of animal meat or the like. By adding moisture thereto, the animal meat paste becomes relatively low in stickiness, that is, in viscosity, so that the animal meat paste becomes fluid. Moisture injected may be added gradually while a viscous state of the animal meat paste is observed. During the grinding step using the grinding machine, seasonings and the like may be added besides moisture and albumen.

The paste chicken meat manufactured by the grinding machine is moved into a hopper, and thereafter a viscosity of the paste chicken meat is enhanced in a preheating step. Since the ground animal meat paste has characteristics of low viscosity and high fluidity, the animal meat paste flows in a conveyance path formed by a pipe and the like and is conveyed so that the animal meat paste generates heat by current which flows in the animal meat paste and which is caused by an electrode provided in the pipe during a preheating step. Due to this, the animal meat paste is heated because of the heat generated by joule heat, and a viscosity thereof becomes higher than that of before-heating so that the animal meat paste begins becoming sticky. And that if the animal meat paste is heated by the joule heat, the animal meat paste is heated at a substantially uniform temperature as a whole. Then, a heating temperature of the animal meat paste is 60° C. or less.

The animal meat paste whose viscosity is increased by preheating in the preheating step is injected into the molds and is formed in predetermined shapes in a forming step. Each of the shapes formed is flatness as a whole and seems a copy of leaves of trees or bamboos, or the like.

The formed animal meat paste is heated up to a production temperature in a main heating step. In the main heating step, with the animal meat paste put between a pair of electrode plates, the animal meat paste is heated because of heat generation caused by the joule heat since current flows in the animal meat paste from the electrode plates. By heating the formed animal meat paste due to joule heat, the inside of the animal meat paste is heated at a desired temperature. This production temperature is 75° C. or more. The animal meat paste becomes animal meat pasty food products which have such elasticity as to be capable of keeping each shape thereof and which have a soft sense of eating.

Additionally, in the case of providing burning colors with each surface of the animal meat pasty food products, each surface thereof is heated in a surface finishing heating step. As this surface finishing heating step, a hot air oven or the like is used. By exposing the animal meat pasty food products to a high temperature atmosphere using gas or electricity as a source, each surface of the animal meat pasty food products is heated. However, in the case of not providing burning colors with each surface thereof, the surface finishing heating step is not required.

These animal meat pasty food products are manufactured such that a processing material is manufactured by using chicken meat as a raw material, breaking the chicken meat to pieces to make minced meat, soaking the minced meat into water to remove fat thereof floating on a water surface, and the animal meat paste is manufactured by using the processing material, grinding the processing material by the grinding machine. Therefore, the animal meat pasty food products has had a little fat and low calorie and a soft sense of eating.

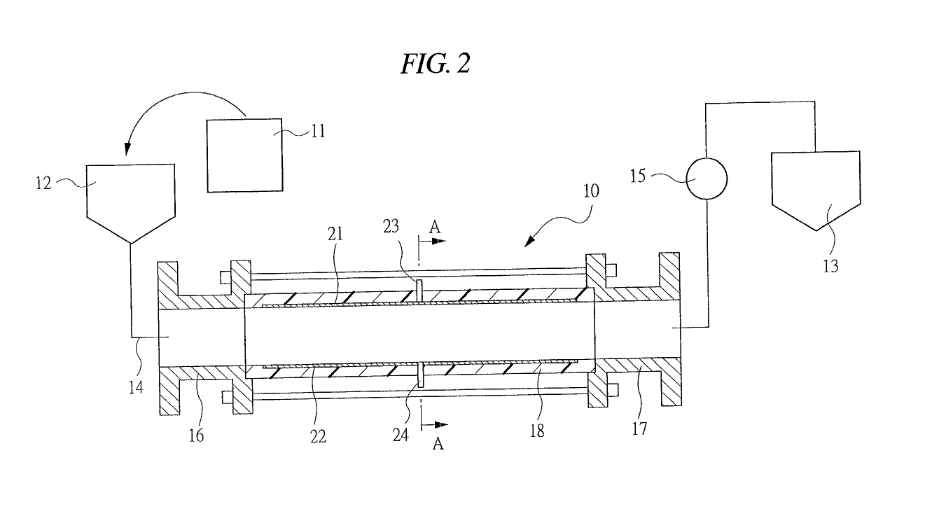

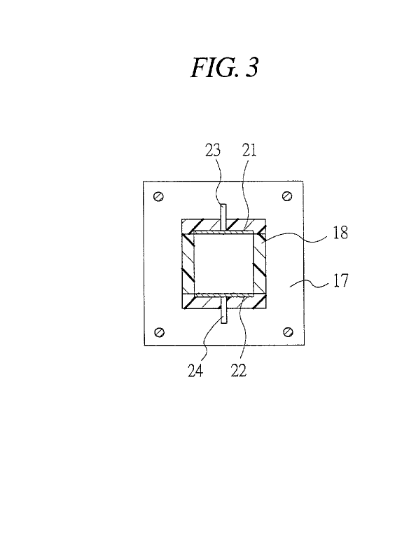

FIG. 2 is a cross-sectional view of a preheating system. FIG. 3 is a cross-sectional view taken along line A-A in FIG. 2. This preheating system 10 is provided at a conveyance path 14 connected between hoppers 12 and 13. The hopper 12 is one in which the animal meat paste that is formed by grinding the above-mentioned fat-removed processing material along with salt, moisture, albumin and the like by the grinding machine 11 and that has stickiness is thrown. The hopper 13 receives the animal meat paste provided with a viscosity by a preheating system 10. A pump 15 is provided in this conveyance path 14 in order to move, in the conveyance path 14, the animal meat paste thrown in the hopper 12. This pump 15 may be arranged on an upstream or downstream side of the preheating system 10 in the conveyance path 14.

The preheating system 10 has a joint section 16 connected to a upstream side of the conveyance path 14, and a joint section 17 connected to a downstream side thereof. A pipeline 18 made of a insulating material such as quadrilateral sectional resin or the like is fixed between these joint sections 16 and 17. Electrode plates 21 and 22 are provided on two inner surfaces opposed to each other in this pipeline 18. Respective electrode plates 21 and 22 are connected to terminals 23 and 24 which connect to a current control apparatus not shown through cables. Thereby, normal power or high-frequency power is supplied to each of the electrode plates 21 and 22. Although the illustrated pipeline 18 has a quadrilateral section, it can also have a circular section instead.

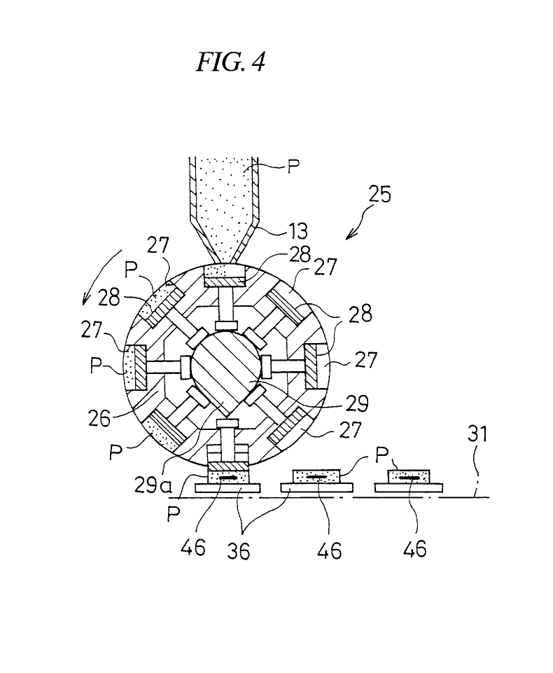

FIG. 4 is a cross-sectional view showing one example of a forming apparatus 25 located below the hopper 13 shown in FIG. 2. The forming apparatus 25 has a rotary body 26 that is rotated and driven by a drive shaft not shown. A plurality of flat recesses 27 corresponding to shapes of the animal meat pasty food products to be formed is arranged in an outer circumferential portion of the rotary body 26. A discharge port of the hopper 13 is formed to face an outer circumferential surface of the rotary body 26. By rotating the rotary body 26, the animal meat paste P in the hopper 13 is injected into each recess 27 and is formed in predetermined shapes.

Ejecting members 28 are provided in the rotary body 26 so as to form each bottom surface of the recesses 27. Respective ejecting members 28 are slidable in a radial direction of the rotary body 26. When respective recesses 27 move from a position of an upper portion of the rotary body 26 to a position of a lower portion thereof in accordance with rotation of the rotary body 26, a cum member 29 is assembled in a rotary center portion of the rotary body 26 in order to discharge, from the lower portion, the animal meat paste P formed after injection from the upper portion. The cam member 29 is fixed to a supporting member not shown. When the ejecting member 28 moves up to a position of a projection 29a provided at a lower end of the cam member 29, the ejecting member 28 is moved outside a radial direction thereof so that the animal meat paste P injected in the recesses 27 is discharged in a lower direction away from the rotary body 26.

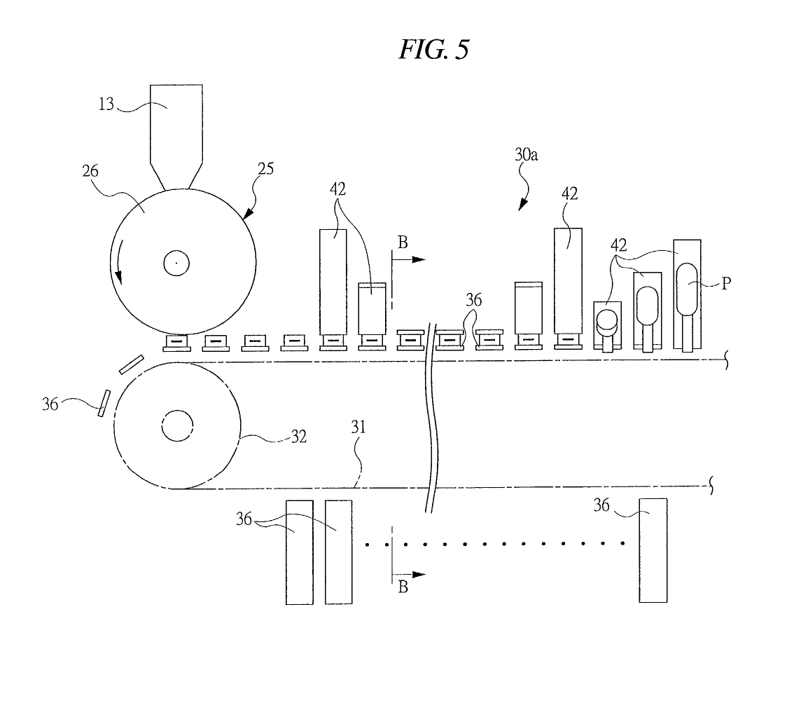

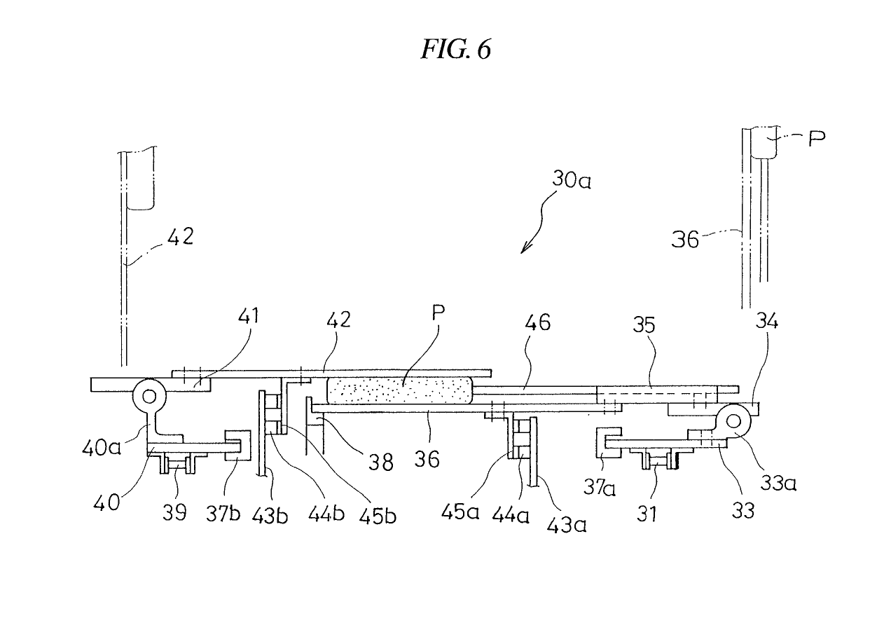

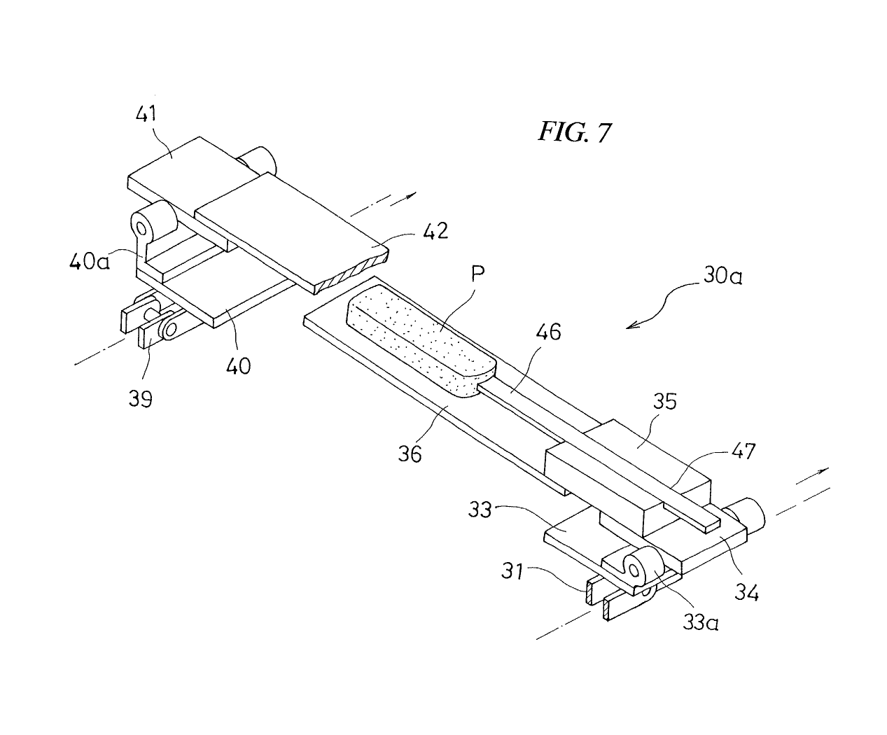

FIGS. 5 to 7 are views showing a main heating system used as a main heating means for heating the animal meat paste P formed in predetermined shapes, up to a production temperature by the forming apparatus 25. FIG. 5 is a front view of the main heating system. FIG. 6 is a cross-sectional view taken along line B-B in FIG. 5. FIG. 7 is a perspective view of FIG. 6.

This main heating system 30a is located below the forming apparatus 25 and has a chain conveyer 31 formed by an endless roller chain. The chain conveyer 31 is wound around a sprocket 32 at an upstream end thereof and around another sprocket not shown at a downstream end thereof. The chain conveyer 31 can circulation-move, with the chain conveyer 31 supported by these sprockets. Coupling members 33 as shown in FIG. 6 are fixed to this chain conveyer 31 per predetermined interval. A swaying member 34 is fitted to each coupling member 33 through a hinge portion 33a. An electrode plate 36 is fitted to the swing member 34 and fixed to a holder 35 made of an insulating material such as resin or the like.

A guide member 37a guiding movement of the coupling members 33 along the chain conveyer 31 is provided in parallel with the chain conveyer 31. A guide member 38 is provided along and in parallel with the chain conveyer 31 in order to support a tip portion of each electrode plate 36 that is in a horizontal state and to guide movement of each electrode plate 36. As a result, each electrode plate 36 is guided by the guide members 37a and 38 and thereby moves a right and left directions in FIG. 5, and sways between a vertical state indicated by doubly dotted broken lines and a horizontal state indicated by solid lines in FIG. 6.

As shown in FIG. 6, a chain conveyer 39 is provided along and in parallel with the chain conveyer 31. Coupling members 40 are fitted to this chain conveyer 39 per predetermined interval. A swaying member 41 is fitted to each coupling member 40 through a hinge portion 40a. Electrode plates 42 are fixed on the swaying member 41 through an insulating member not shown. A guide member 37b guiding movement of each coupling member 40 along the chain conveyer 39 is provided in parallel with the chain conveyer 39. As a result, each electrode plate 42 is guided by the guide member 37b and thereby moves a right and left directions in FIG. 5, and sways between a vertical stated indicated by doubly dotted broken lines and a horizontal state indicated by solid lines in FIG. 6.

The electrode plates 36 fitted to the chain conveyer 31 through the hinge portion 33a or the like and the electrode plates 42 fitted to the chain conveyer 39 through the hinge portion 40a or the like are provided to form so many pairs. The respective electrode plates 36 and 42 are made of electrically conductive materials such as metal or the like. In such a state that the animal meat paste P formed by the forming apparatus 25 is put between both electrode plates 36 and 42, when current flows in the animal meat paste P from the electrode plates 36 and 42, joule heat is generated in the animal meat paste P and the animal meat paste P is heated up to the production temperature by the joule heat.

In order to supply power to the respective electrode plates 36 and 42, power feeding electrodes 44a and 44b are provided on supporting members 43a and 43b arranged along the chain conveyers 31 and 39, respectively. Power feeding brushes 45a and 45b contacting the power feeding electrodes 44a and 44b are fitted on the electrode plates 36 and 42, respectively.

As shown in FIG. 7, a skewer holding groove 47 for holding a skewer member 46 is formed in each holder 35. Immediately before or after the animal meat paste P is made to fall on each electrode plate 36 from the forming apparatus 25, the skew member 46 is thrust in the animal meat paste P while inserted into the skewer holding groove 47. Therefore, after the skew member 46 is thrust therein, the animal meat paste P thrown into an upper portion of each electrode plate 36 located in a lower side of the heating system 30a from the forming apparatus 25 is put between both electrode plates 36 and 42 by each electrode plate 42 which is located in an upper side thereof and which transforms into a horizontal state from a vertical state to contact the animal meat paste P, and is conveyed from an upstream side to a downstream side. During this conveyance step, high frequency power is supplied to the animal meat paste P from an external power supply and thereby the animal meat paste P is heated by the joule heat.

In the downstream side of the main heating system 30a, each electrode plate 42 goes away from the animal meat paste P and a position thereof changes to be directed at a vertical direction. After each electrode plate 42 goes away from the animal meat paste P, each electrode plate 36 pushes up the animal meat paste P and a position of the animal meat paste P pushed up changes to be directed at a vertical direction. As the chain conveyer 31 is transferred, each position of the electrode plates 36 changes by contact between each electrode plate 36 and an up-transformed portion of the guide member 38. Similarly, as the chain conveyer 39 is transferred, each position of the electrode plates 42 changes by a guide member not shown.

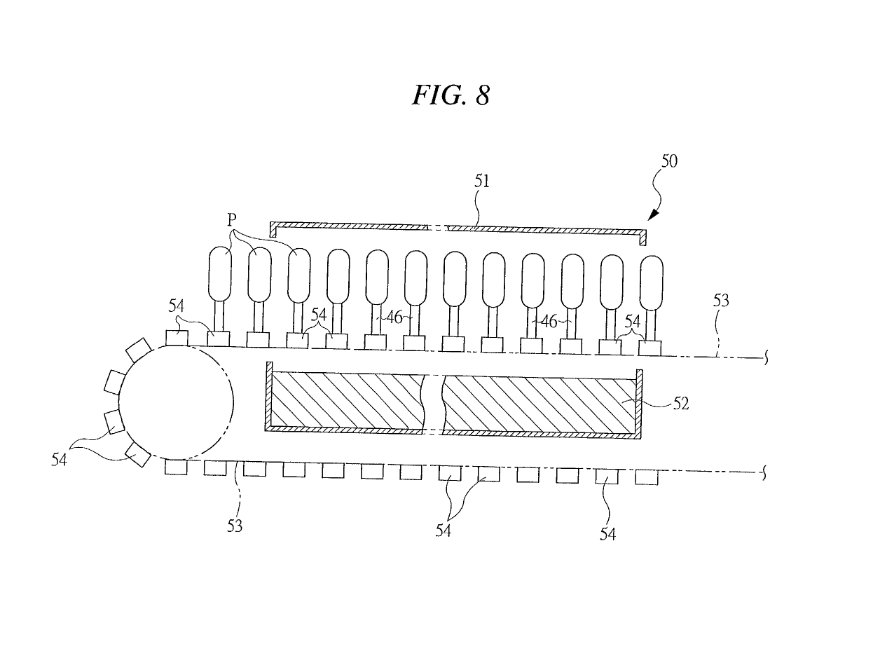

FIG. 8 is a cross-sectional view showing a burning oven 50 used as a surface finishing heating step. A heater 52 using electric or gas as a heating source is provided inside an oven body 51. Additionally, a chain conveyer 53 can move in the oven body 51. After being main-heated, the animal meat paste P is transferred from the chain conveyer 31 of the main heating system 30a to the chain conveyer 51 thereof, and is conveyed in a vertical state that a position thereof is kept. Skew holders 54 for supporting the skew members 46 are fitted to the chain conveyer 53 per predetermined interval. Since the inside of the burning oven 50 becomes a heating atmosphere by radiant heat or the like generated by the heater 52, each surface of the animal meat paste P is provided with burning colors. However, in the case of not providing burning colors, this finishing heating step is omitted, and the animal meat paste P is packaged after being main-heated and becomes food productions as it is.

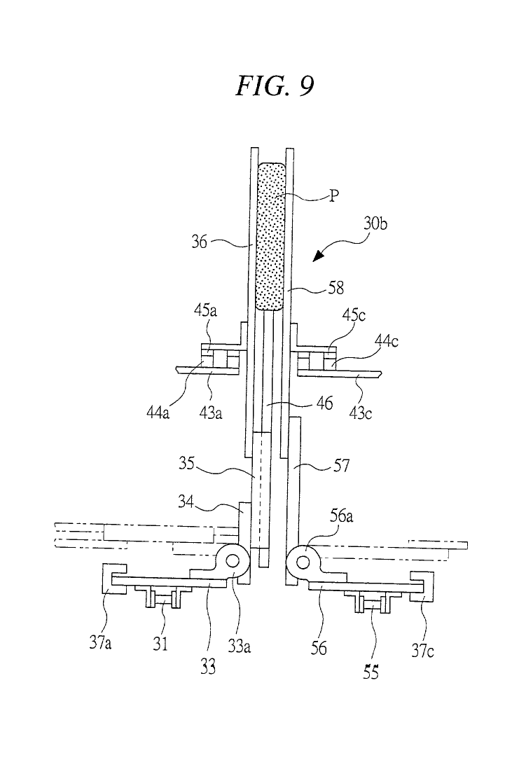

FIG. 9 is a view showing a modified example of a main heating system heating the animal meat paste P formed in predetermined shapes by the forming apparatus, up to the production temperature. While the heating system shown in FIGS. 5 to 7 heats the animal meat paste P in a horizontal state, this main heating system 30a heats the animal meat paste P in a vertical state. The main heating system includes a chain conveyer 31 having the same structure as the chain conveyer 31 shown in FIGS. 5 to 7, and another chain conveyer 51 arranged symmetrically relative thereto.

Coupling members 56 shown in FIG. 9 are fitted to the chain conveyer 55 per predetermined interval. A swaying member 57 is fitted to each coupling member 56 through a hinge portion 56a. Each electrode plate 58 is fixed to each swaying member 57 through an insulating member not shown. A guide member 37c for guiding movement of each coupling member 56 along the chain conveyer 55 is provided in parallel with the chain conveyer 55. A power feeding brush 45c is fitted even to each of these electrode plates 58. The power feeding brush 45c is in contact with a power feeding electrode 44c provided on the supporting member 43c.

Thus, in the main heating system 30b shown in FIG. 9, the animal meat paste P formed by the forming apparatus 25 is thrown onto each electrode plate 36 that is held in a horizontal state. After the skewer member 46 is thrust in the animal meat paste P, as the chain conveyer 31 is conveyed, each electrode plate 36 is guided by a guide member not shown and a position thereof is changed to a vertical state. To correspond to the position of each electrode plate 36 changed to a vertical state, each electrode plate 58 provided at the chain conveyer 58 is also guided by a guide member not shown and a position thereof is changed in a vertical state. Therefore, the animal meat paste P is put between both electrode plates 36 and 58. Under this state, current flows into the animal meat paste P from both electrode plates 36 and 58, and thereby the animal meat paste P is heated.

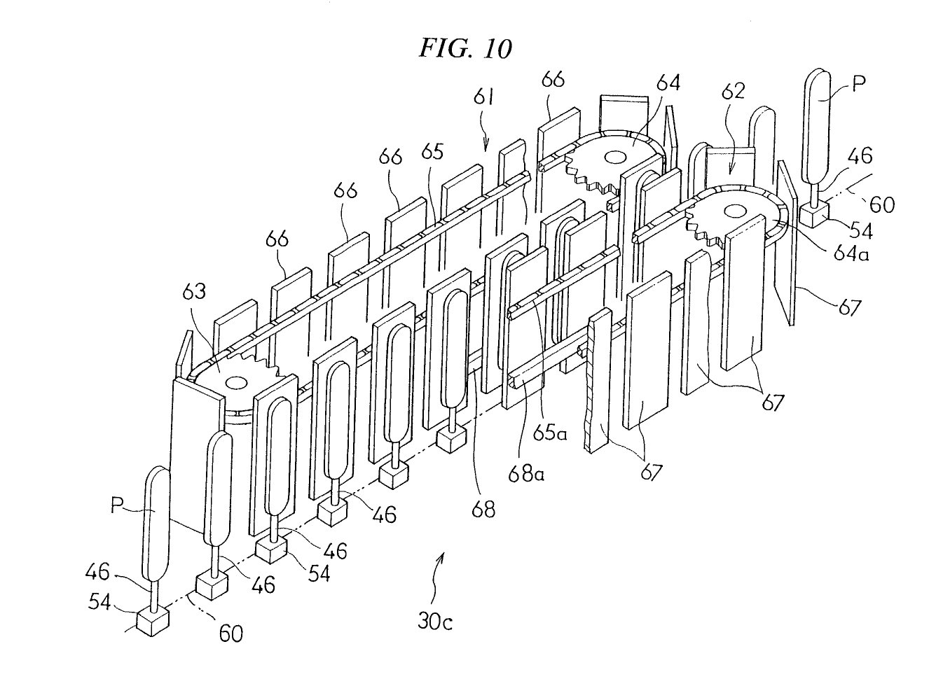

FIG. 10 is a perspective view showing still another example of the main heating system that heats the animal meat paste P formed in predetermined shapes by the forming apparatus 25, up to the production temperature. Similarly to the case shown in FIG. 9, this main heating system 30c heats the animal meat paste P that is kept in a vertical state, but electrode plates and conveyers conveying the electrode plates in this case are different from those in the above-mentioned case.

As shown in FIG. 10, this main heating system 30c has a chain conveyer 60. The chain conveyer 60 holds and conveys such the animal meat paste P in which each skew member 46 is thrust as to be in a vertical state by the skew member 46. Skewer holders 54 similar to the skew holders shown in FIG. 8 are fitted to this chain conveyer 60 per predetermined interval. Current flowing conveyers 61 and 62 are arranged in both sides of the chain conveyer 60. The current flowing conveyer 61 has two sprockets 63 and 64 arranged away from each other, and a chain conveyer 65 provided between the sprockets 63 and 64. Electrode plates 66 are fitted on the chain conveyer 65 per predetermined interval to be directed to a vertical direction. The current flowing conveyer 62 has the same structure as the current flowing conveyer 61, and has a chain conveyer 65a provided between two sprockets. Electrode plates 67 are fitted to the chain conveyer 65a per predetermined interval to be directed to a vertical direction. One sprocket 64a of two sprockets between which the chain conveyer 65 is provided is shown in the drawing and the other sprocket is omitted.

Thus, each space is formed between two electrode plates 66 and 67 opposite to one another in both sides of the chain conveyer 60, and thereby the animal meat paste P is put in each space. Therefore, the animal meat paste P thrust in the skew member 46 and conveyed by the chain conveyer 60 is put between the electrode plates 66 and 67 fitted to the chain conveyers 65 and 65a synchronizing the movement of the chain conveyer 60, and is conveyed.

Power feeding members 68 and 68a made of electrically conductive materials are arranged at respective current flowing conveyers 61 and 62 to be in contact with respective inner surfaces of the electrode plates 66 and 67 and to extend in a conveying direction. Power from a power supply unit not shown is supplied to the respective power feeding members 68 and 68a.

As described above, according to the present invention, the chicken meat ground along with salt and moisture by the grinding machine 11 after being fat-removed is transformed to the animal meat paste having fluidity but does not contain fat. Thereby, it is possible to obtain the animal meat pasty food productions having low fat and low calorie. The animal meat paste having high fluidity and weak stickiness caused by addition of moisture can not be formed in predetermined shapes as it is. However, when the animal meat paste moved in the pipeline is heated at a temperature of 60° C. or less by current flowing from the electrode plates 21 and 22 provided in the pipeline, the animal meat paste having had high fluidity begins becoming sticky and thereby has high viscosity. The animal meat paste having high viscosity is formed in predetermined shapes by the forming apparatus 25, and thereafter is heated at a production temperature of 75° C. or more by the main heating. As a result, the animal meat pasty food products having high elasticity and a good sense of eating are manufactured.

Particularly, the animal meat such as chicken meat or the like is used as a raw material. However, since fat thereof is removed therefrom, it is possible to manufacture animal meat processing food products (animal meat pasty food products) which have low calorie and a soft sense of eating and which are healthy. Since the animal meat which is a raw material can be cut to pieces or used as minced meat, it is possible to use, as a raw material, parts of bone-containing meat or the like that has hardly been utilized recently, and thereby to attain effective utilization of natural resources. Therefore, the animal meat that is a raw material becomes better food products from a viewpoint of little natural resources.

The present invention is not limited to the above-described embodiments, and can be variously modified without departing from the gist thereof. For example, to avoid direct contact between each electrode plate and the animal meat paste on each surface of the electrode plates 36, 42, 58, 66 and 67 for the main heating as described above, water permeable films may cover at least one of the electrode plates and the animal meat paste. A water permeable film may be a thin film having a property containing moisture such as cellophane, paper, cloth, non-woven cloth, or the like. As the water permeable films, various kinds of film or membrane materials may be utilized which are generally called hydrophilic film, water absorbing film, water holding film or the like.

In the main heating system 30 shown in FIGS. 5 to 7, while the animal meat paste is kept and conveyed in a horizontal state, current flows in the animal meat paste. In the main heating system 30b shown in FIG. 9 and in the main heating system 30c shown in FIG. 10, while the animal meat paste is kept and conveyed in a vertical state, current flows in the anima meat paste. However, even if the heating system for the main heating after the animal meat pasty food products are formed in predetermined shapes adopts any types described above, it is possible to make current flow therein. Particularly, even in the case of being kept in a vertical state, since the animal meat paste formed have such elasticity as to be capable of maintaining desirable shapes, each shape thereof is not broken during conveyance.

As shown in FIG. 10, by the main heating system 30c which is such a type as to directly fit the electrode plates 66 and 67 on the chain conveyers 65 and 65a, if the position of the system is rotated up to 90° to make the respective electrode plates 66 and 67 in a horizontal state, it is possible to keep the animal meat paste in a horizontal state and heat it by current flowing therein. In the case of making current flow during conveyance in a horizontal state, unless the finishing heating is preformed in a vertical state thereof, it is unnecessary to thrust each skew member 46 in the animal meat paste.

Although the animal meat pasty food products shown in the drawings use chicken meat as a raw material, other animal meat such as pork, beef or the like other than the chicken meat can be also used as a raw material. A mixture of plural kinds of animal meats may be used as a raw material. Fish meat may be included in the mixture.

According to the present invention, when the animal meat paste is manufactured by using, as a raw material, animal meat such as chicken meat or the like, oil substances are removed from the animal meat paste and moisture is added thereto without adding fat. Therefore, it is possible to obtain the animal meat pasty food products having low fat. Although the animal meat paste having fluidity and little stickiness can not be formed by the forming apparatus as it is, the animal meat paste begins becoming sticky and a viscosity thereof is high by first preheating the animal meat paste at a temperature of 60° C. or less by the joule heat. It is possible to form the animal meat paste in desirable shapes by forming the high viscous animal meat paste by the forming apparatus. Since the main heating system heats the animal meat paste up to a production temperature of 75° or more after formation thereof, the animal meat pasty food productions having lower fat and a good sense of eating can be obtained.

What is claimed is:

1. A method of manufacturing an animal meat pasty food product comprising:
a fat-removing step of soaking an animal meat such as a chicken meat in water and removing fat thereof floating on a surface of water;
an animal meat grinding step of grinding the fat-removed animal meat to which salt is added, along with seasonings such as moisture and albumen by a grinding machine, and thereby manufacturing an animal meat paste;
a preheating step of heating said animal meat paste by joule heat generated by current flowing therein, and thereby enhancing a viscosity of said animal meat paste;
a forming step of forming the animal meat paste whose the viscosity is enhanced, in a predetermined shape; and
a main heating step of heating the formed animal meat paste by joule heat generated by current flowing therein, up to a production temperature.

2. A method of manufacturing an animal meat pasty food product comprising:
an animal meat grinding step of grinding an animal meat such as a chicken meat along with salt and moisture, and thereby forming an animal meat paste;
a preheating step of heating said animal meat paste by joule heat generated by current flowing therein, and thereby enhancing a viscosity of said animal meat paste;
a forming step of forming the animal meat paste whose the viscosity is enhanced, in a predetermined shape; and
a main heating step of heating the formed animal meat paste by joule heat generated by current flowing therein, up to a production temperature.

3. The method according to claim 1, wherein said preheating step is a step of heating said animal meat paste up to a temperature of 60° C. or less, and said main heating step is a step of heating said animal meat paste up to a temperature of 75° C. or more.

4. An apparatus for manufacturing an animal meat pasty food product comprising:
a grinding machine for grinding an animal meat such as a fat-removed chicken meat along with salt and moisture, and thereby manufacturing an animal meat paste;
a preheating means for heating said animal meat paste by joule heat generated by current flowing in said animal meat paste, and thereby enhancing a viscosity of said animal meat paste;
a forming apparatus for forming the animal meat paste whose the viscosity is enhanced, in a predetermined shape; and
a main heating means for heating the formed animal meat paste by joule heat generated by current flowing therein, up to a production temperature.

5. The apparatus according to claim 4, wherein said preheating means heats said animal meat paste up to a temperature of 60° C. or less, and said heating means heats said animal meat paste up to a temperature of 75° C. or more.
